(19) United States
(12) Patent Application Publication
(10) Pub. No.: US 2011/0138664 A1
(43) Pub. Date: Jun. 16, 2011

(54) FRAME WITH REMOVABLE SIGN

(76) Inventor: KERRY WELLS, Spanish Lake, MO (US)

(21) Appl. No.: 13/033,394

(22) Filed: Feb. 23, 2011

Related U.S. Application Data
(63) Continuation-in-part of application No. 12/614,197, filed on Nov. 6, 2009.

(51) Int. Cl. G09F 13/00

(52) U.S. Cl. 40/541

(57) ABSTRACT

A frame with removable sign has a rectangular opaque housing, a translucent cover, two parallel rails spaced apart upon the longitudinal edges of the cover and a stile connecting to the ends of the rails upon one lateral edge of the cover, a face panel sliding over the cover where the face panel includes various indicia, and magnets and adhesive for non-mechanical securement of the sign. The face panel sliding engages the cover and remains in place using friction or a mechanical means. The face panel has its indicia as transparent upon an opaque background. The housing also includes an embodiment capable of attachment to a vehicle. The frame with removable sign fits upon a housing that suspends from a window, door, fence rail, or other linear shape.

### CROSS REFERENCE TO RELATED APPLICATION

This continuation in part application claims priority to the pending non-provisional application for patent Ser. No. 12/614,197 filed Nov. 6, 2009 which is commonly owned by the same inventor.

### BACKGROUND OF THE INVENTION

The frame with removable sign generally relates to signage and more specifically to a frame that releasably mounts to a supporting surface and receives a rectangular sign upon three edges.

For years, people have placed for sale signs in windows, secured by tape and suction cups, generally upon the interior of a building. Builders have also installed house numerals upon homes near the front door. The numerals have a color generally contrasting with the home's décor for visibility. On select homes, lighting illuminates house numerals indirectly. Signs and numerals either connect poorly to a house, such as tape in a window, or call for fixed installation.

For garage sales, political campaigns, and other causes, people often place signs in their yards or other permitted locations. The signs generally display information about an event, a slogan, a candidate, or serve as an advertisement. The signs have various metal frames and sometimes wooden stakes for securement in an upright position upon a supporting surface, usually the ground. However, the signs, generally placards, lack direct illumination and remain dark. Select contrasting colors and certain reflective tapes provide indirect illumination particularly when a headlight casts its beam upon a sign. Without a headlight beam, most signs remain unseen during darkness and inclement weather.

### DESCRIPTION OF THE PRIOR ART

In windows and yards, and alongside sidewalks across the country, various signs advertise and promote a host of events, causes, and functions. Garage sale signs appear at street corners in spring and stay through summer. Some garage sale signs are stapled upon various utility poles and in time utilities and government agencies remove the signs. Other garage sale signs, generally poster board, have stakes behind them pounded into the ground. The poster signs generally have a short life, appearing about a week before the garage sale. The garage sale organizer then removes the signs after the sale. Signs forgotten then succumb to the elements, transforming from a rigid planar poster into a damp clump of paperboard.

When an election nears, political signs appear in yards and along roadways where permitted by ordinance and statute and also in other locations not so permitted. Political signs are generally planar poster board laminated on the printed surface. Less expensive political signs often use poster board subject to the same degradations as garage sale signs. For a simple installation of a political sign, a volunteer pounds a wooden stake into the ground and then places the political sign over the stake. Occasionally, the political sign is placed over the stake before pounding it into the ground. This leads to the sledge hammer compressing the sign material over the stake, leading the sign to slip down the stake in a few days. Other political signs install upon wire frames. The simple wire frame is generally 3/16 inch steel wire bent into a U shape and inverted. For installation, a volunteer pushes the wire legs into the ground and then slips the sign over the frame. Installation generally calls for damp earth, that is, not hardened or stiff from a drought. A better steel frame utilizes a cooperating sign board with hollow corrugations. The frame has a generally Y shape with two uprights that insert into corrugations of the sign and two opposite, narrowly spaced legs. The legs are joined by a foot jack about four to five inches from their end. A volunteer places the sign upon the uprights, locates the sign in position, and then steps on the foot jack pushing the legs into the ground. Volunteers of limited strength have installed the foot jack frames without much trouble.

Political signs also include various bumper strips, formerly bumper stickers. The bumper strips secure to a surface, often a vehicle, using a releasable adhesive layer. The bumper strips secure to a vehicle generally during campaign season and a vehicle driver then readily removes the bumper strip by peeling a corner once the campaign ends. Though bumper strips for political purposes have been described, bumper strips have seen and still see use for displaying various slogans and sayings, often independent of politics.

The bumper strips, political signs, garage signs, and window signs though generally require external illumination for reading. Most signs can be read easily during daytime using sunlight. However, after night fall and during bad weather, the signs often escape view by drivers and passersby on foot. As mentioned previously, some signs include high contrast colors and various reflectors however, few signs suitable for home use, that is not on billboards, have illumination.

The present invention overcomes the difficulties of signs escaping visibility at night and signs with a single way of securing to a surface. The present invention provides a frame that receives a sign panel slid longitudinally into the frame. Also the present invention includes multiple components for securement to a surface and components for direct illumination of the sign during periods of darkness as in night or bad weather.

### SUMMARY OF THE INVENTION

Generally, the frame with a removable sign has a rectangular opaque housing, a translucent cover, two parallel rails spaced apart upon the longitudinal edges of the cover and a stile connecting to the ends of the rails upon one later edge of the cover, a face panel sliding over the cover where the face panel includes various indicia, hooks and spikes for mechanical securement of the sign, magnets and adhesive for non-mechanical securement of the sign, a power supply, various sensors to control and to regulate illumination of the sign, and light sources. The face panel sliding engages the cover and remains in place using friction or a mechanical means. The face panel has its indicia as transparent upon an opaque background. The housing also includes an embodiment capable of attachment to a vehicle. The light sources are generally light emitting diodes of predetermined coloration. The frame with removable sign fits upon a housing that suspends from a window, door, fence rail, or other linear shape.

There has thus been outlined, rather broadly, the more important features of the invention in order that the detailed description thereof that follows may be better understood and that the present contribution to the art may be better appreciated. The present invention also includes j-channel members, a translucent cover, a locking notch, curved hooks, pointed stakes, adhesive strips, magnetic strips, power sources including utility service, battery, and solar cells, indicia including letters, numerals, and logos, dusk to dawn sensors, an accelerometer, a manual ON/OFF switch, and an automatic OFF switch in combination with the accelerometer. Also, the LED as a light source are provided in groups of at least two diodes. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a frame with removable sign that readily installs upon the ground, a building, or a vehicle.

Another object is to provide such a frame with removable sign that remains visible during daytime, night, and inclement weather.

Another object is to provide such a frame with removable sign that allows for ready installation and changing of a sign while an housing remains fixed.

Another object is to provide such a frame with removable sign that need not require tools to install or change a sign upon a housing.

Another object is to provide such a frame with removable sign that provides for semi-automatic control for both on/off and daylight sensing.

Another object is to provide such a frame with removable sign that has a low cost of manufacturing so the purchasing consumers and organizations can readily buy the illuminated sign with supports through stores and supply sources. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a front view of an illuminated sign of the invention;

FIG. 2 is a back view of the illuminated sign;

FIG. 3 is a top view of the illuminated sign;

FIG. 4 is a bottom view of the illuminated sign;

FIG. 5 is a left side view of the illuminated sign;

FIG. 6 is a right side view of the illuminated sign;

FIG. 7 is an isometric view of the illuminated sign with covers partially open;

FIG. 8 is a front view of the invention with the cover open;

FIG. 9 is an isometric view of an alternate embodiment of the invention;

FIG. 10 is a back view of the alternate embodiment;

FIG. 11 is an exploded view of the alternate embodiment;

FIG. 12 is front view of another alternate embodiment;

FIG. 13 is a front view of the frame and removable sign embodiment;

FIG. 14 is a front view of the sign panel inserted into the frame;

FIG. 15 is a side view of the frame upon a housing;

FIG. 16 is an exploded view of the frame and removable sign proximate a housing; and,

FIG. 17 is a partial exploded view of a panel and cooperating rail.

The same reference numerals refer to the same parts throughout the various figures.

### DESCRIPTION OF THE PREFERRED EMBODIMENT

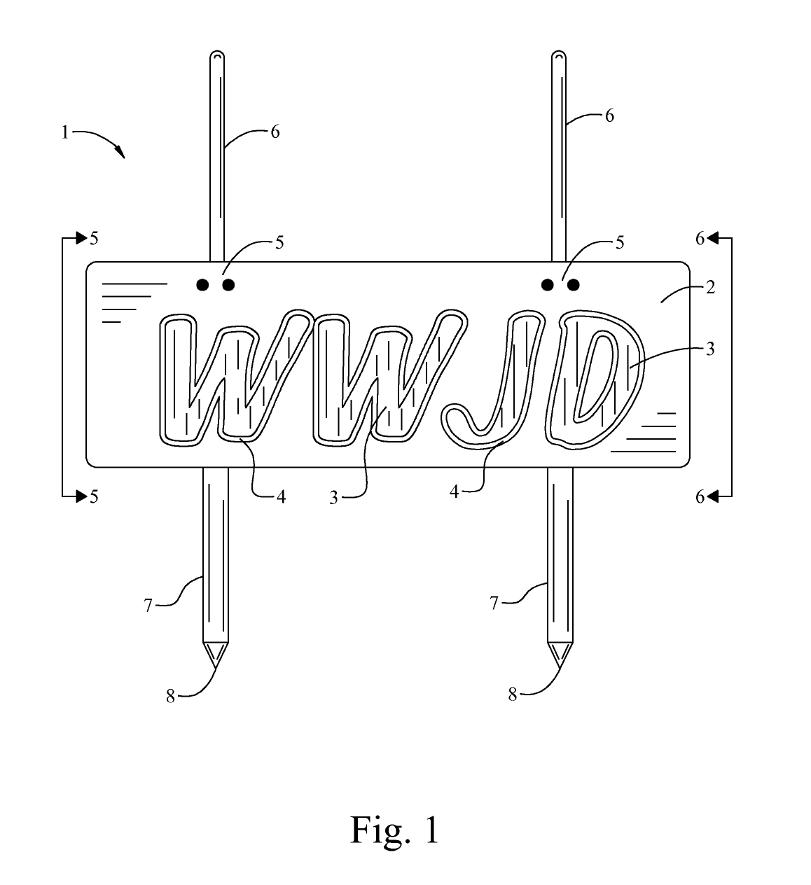

The present art overcomes the prior art limitations by providing an illuminated sign with supports. FIG. 1 shows a front view of the invention 1 in an upright orientation. The invention has a front cover 2, generally rectangular in shape with rounded corners and is generally opaque. The front cover has at least one indicia 3 thereon. Though shown as four letters in this figure, the indicia can take to form of letters, numerals, graphics, or a design. The indicia have a contrasting appearance from the remainder of the front cover, preferably yellow in color indicia upon a black in color front cover.

Though the front cover is generally opaque, the indicia 3 are generally transparent and allow light from within the invention to emanate outwardly as later shown. As letters and numerals, the indicia have individual borders that define them. Each letter and numeral of indicia has their inherent shapes defined by a border of tape, as at 4. The tape adheres to the front cover proximate each letter and numeral without impeding their transparency. Generally the tape outlines each letter and numeral and some select graphics where appropriate. The tape is generally reflective and preferably retro reflective for both day and night visibility in the absence of internal illumination.

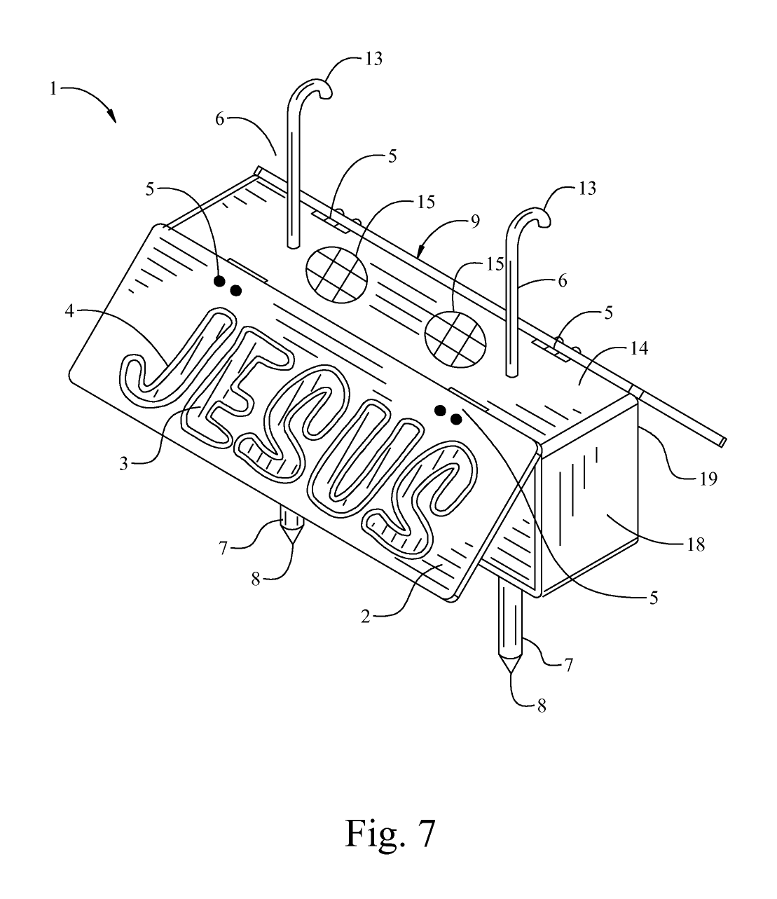

The front cover has at least one hinged connection as at 5 here shown as two hinges. The hinges denote the top of the invention and the indicia are located below the hinges, generally centered upon the front cover. The hinges connect to a housing, later shown in FIG. 7, behind the front cover. Moving outwardly from the hinges, the invention attains its upright orientation using at least one hook 6, here shown as two spaced apart hooks proximate each hinge. The hooks have a generally elongated form and extend perpendicular to the front cover, that is, outwardly from the top of the invention. The hooks as shown allow installation of the invention as suspended from inside of a window, upon a door, or hanging along a line or fence rail.

The present invention also allows installation upright upon the ground proximate a building. Opposite the hooks, the invention has at least one spike 7, here shown as two spaced apart spikes generally below the hinges. The spikes extend outwardly from the invention, generally opposite the hooks. The spikes connect to the invention at the bottom, opposite the top. Each spike is generally elongated and has a length sufficient for embedding into the ground while allowing the invention clearance above the ground. A spike is approximately six to twenty four inches in length, preferably eighteen inches. Opposite the front cover, each spike has a tip 8 that eases embedment into the ground during installation. Preferably, the tip has a conical shape with an apex opposite the remainder of the spike.

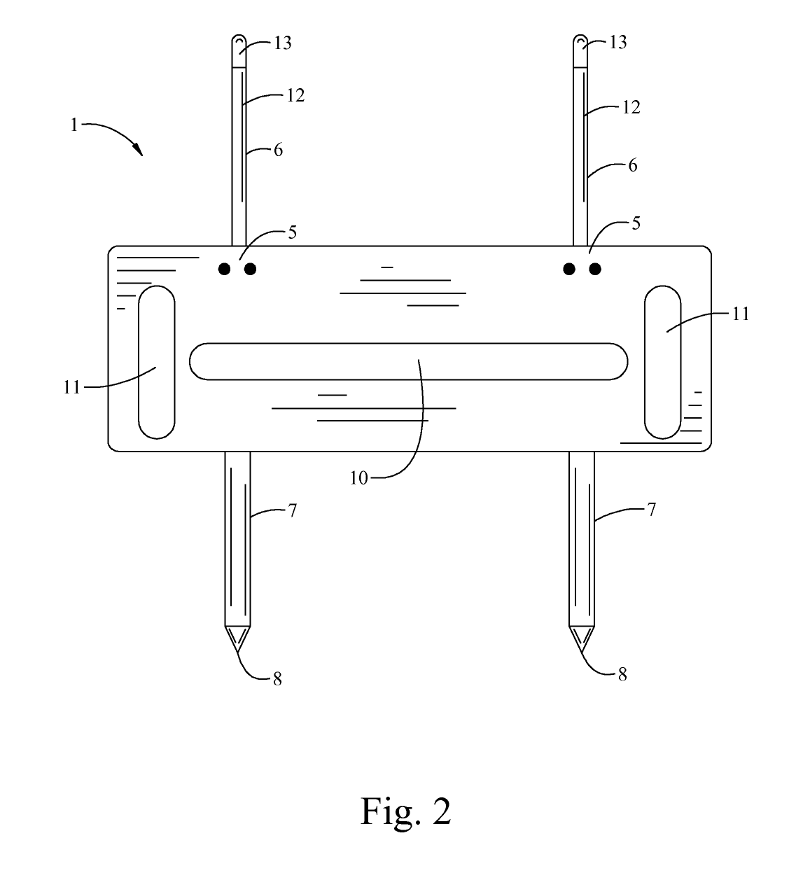

Turning the invention, FIG. 2 shows a rear view of the invention in an upright orientation. The invention 1 has its rear cover 9, generally opaque and rectangular in shape with rounded corners. The rear cover is generally spaced apart from the font cover when closed upon the housing of the invention as shown in this figure. The rear cover does not have any indicia thereon. The rear cover though has at least one horizontal strip 10 and at least one vertical strip 11 that secure the rear cover to another surface such as a building or a vehicle. Preferably, the rear cover has two vertical strips, mutually parallel and spaced apart with the horizontal strip between them as shown. In the preferred embodiment, the horizontal strip and the vertical strips include an adhesive with a release layer thereon. The adhesive binds to wood and masonry after a user removes the release layer at the time of installation. In an alternate embodiment, the vertical strips and the horizontal strips utilize strips of magnetic material affixed to the rear cover and with sufficient strength to support the weight of the invention from a ferrous metal surface, such as a vehicle body panel or bumper. The sizes of the vertical and horizontal strips can be adjusted in this alternate embodiment to provide a strong enough magnetic force.

The rear cover also has at least one hinged connection, as at 5, here shown as two hinges and generally opposite those hinges for the front cover. As before, the hinges denote the top of the invention and the indicia are located below the hinges, generally centered upon the front cover. The hinges connect to a housing, later shown in FIG. 7, behind the rear cover, that is, between the rear cover and the front cover. Moving outwardly from the hinges, the invention attains its upright orientation using at least one hook 6, preferably two spaced apart hooks proximate each hinge. The hooks have a generally elongated form, as at a shank 12, and extend perpendicular to the rear cover, that is, outwardly from the top of the invention. The hooks each have a rounded bight 13 extending outwardly from the shank forming a J shape. The bights of the hooks allow installation of the invention as suspended from inside of a window, on the front of a door, or hanging along a line or fence rail with the bights over the line or fence.

As above, the invention also installs upright upon the ground proximate a building. Opposite the hooks, the invention has at least one spike 7, here shown as two spaced apart spikes generally below the hinges. The spikes extend outwardly from the invention, generally opposite the hooks. The spikes connect to the invention at the bottom, opposite the top. Each spike is generally elongated and has a length sufficient for embedding into the ground while allowing the invention clearance above the ground. A spike is approximately six to twenty four inches in length, preferably about eighteen inches ion length. Opposite the front cover, each spike has a tip 8 that eases embedment into the ground during installation. Preferably, the tip has a conical shape with an apex opposite the remainder of the spike.

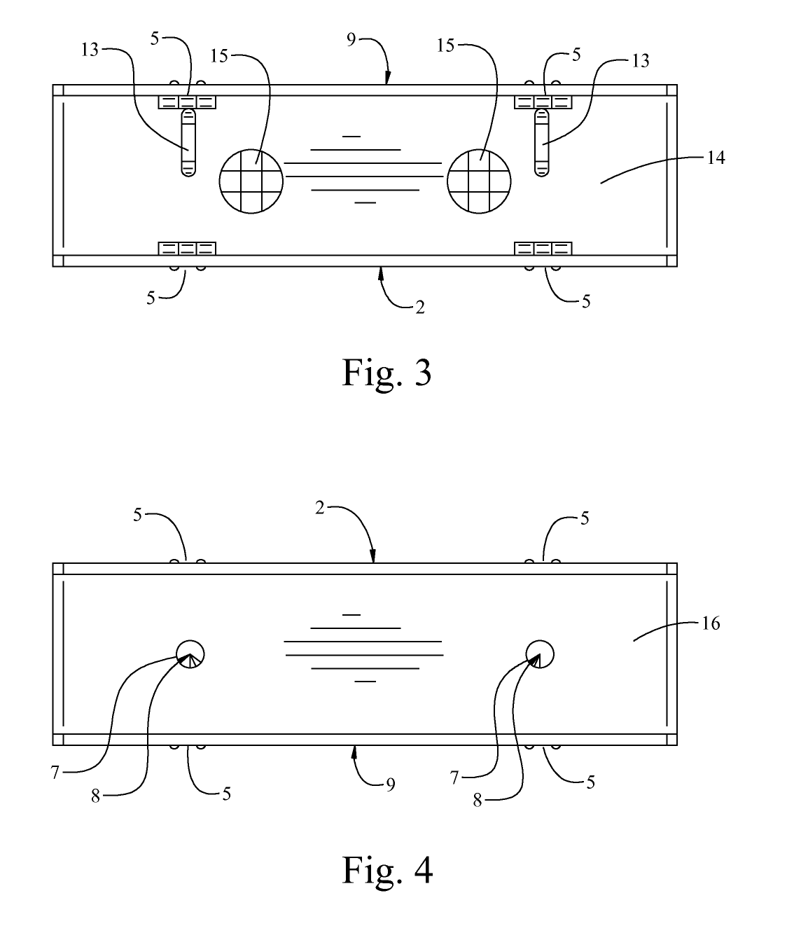

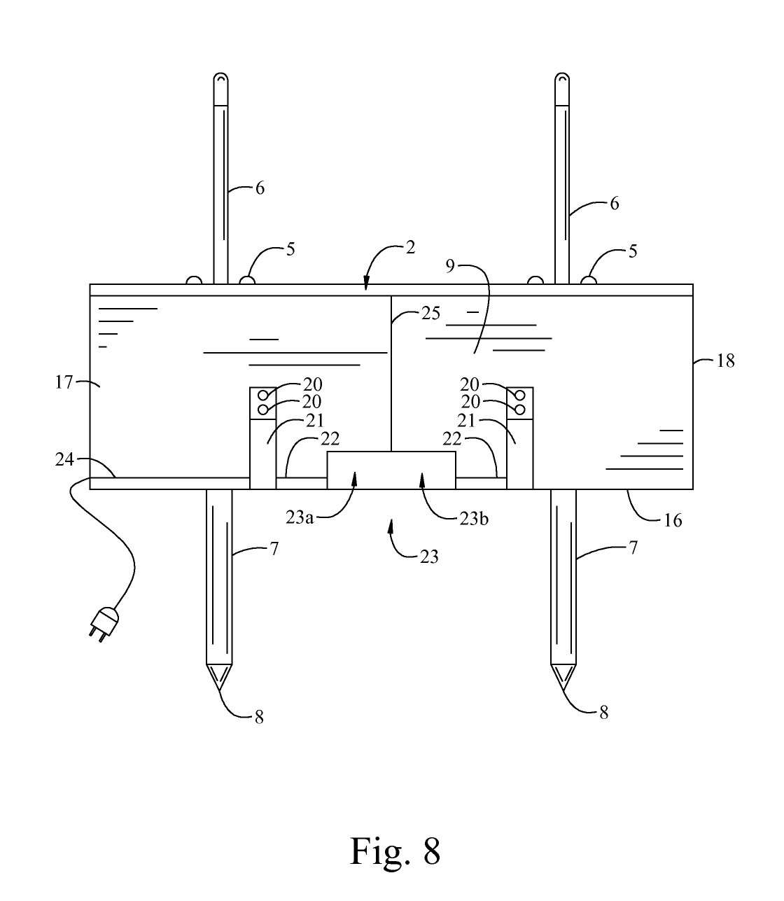

FIG. 3 then shows the invention from the top, that is, above the indicia shown in FIG. 1. The invention has the top of the housing, as at 14, to which connects the hinges 5, here shown as four, two for each cover, and the hooks 6 here showing their bights 13. The top of the housing has a generally rectangular shape with a depth that spaces apart the front cover 2 and the rear cover 9. The top of the housing 14 also includes an alternate embodiment of at least one solar cell 15, here shown as two. The solar cells, locating inwardly from the hooks, capture ambient sunlight falling upon them and create direct current that supplies the illumination for the indicia directly and for charging of at least one battery, later shown in FIG. 8. The solar cells are wired into the electrical system of the invention.

Opposite FIG. 3, FIG. 4 shows the bottom of the invention, generally opposite the hooks and the hinges. The housing has its bottom as at 16, generally rectangular and spaced apart from the top of the housing 14 previously shown. Generally the bottom 16 and the top 14 are parallel and form a box like shape when the covers 2, 9 are closed upon the housing as in FIGS. 1, 2. The bottom 16 provides attachment points for the spikes 7. The attachment points are generally threaded holes in the bottom 16 that receive a threaded end of a spike opposite the tips 8 shown here.

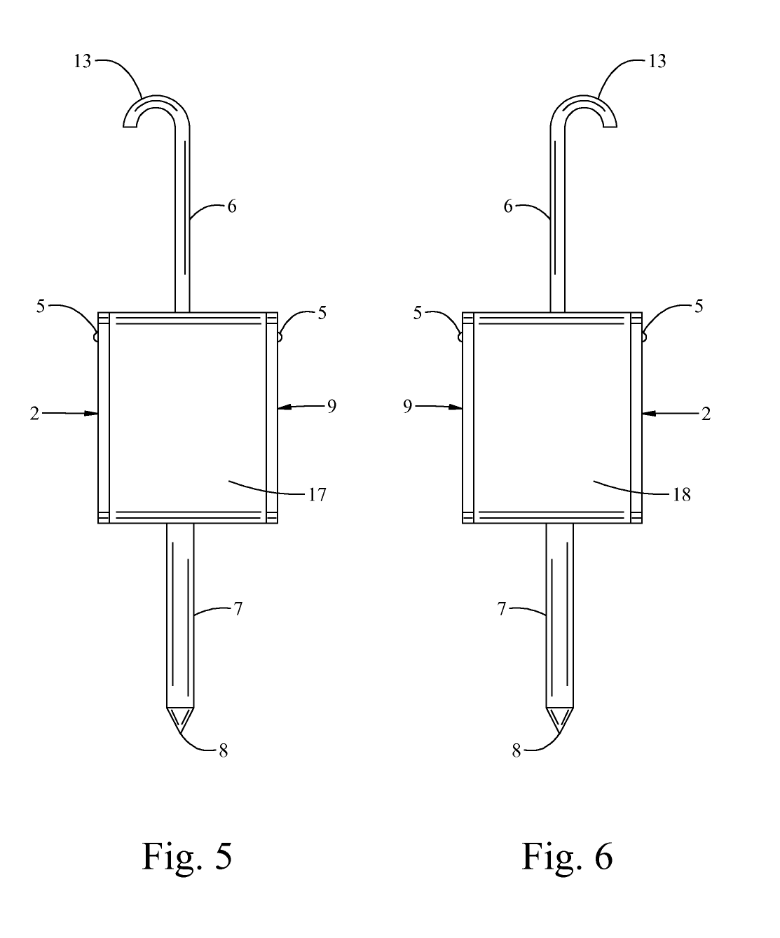

Turning the invention again, FIG. 5 shows the right end of the invention. The invention has a right wall of the housing as at 17 that joins with the top 14 and the bottom 16. The right wall 17 is generally rectangular, and often square in shape. The right wall is slightly recessed from the front cover 2 and the rear cover 9, that is, the covers are slightly longer than the right wall. The overlap in cover length prevents intrusion of moisture within the invention.

And opposite FIG. 5, FIG. 6 shows the left end of the invention with a left wall of the housing as at 18. Similar to the right wall, the left wall 18 has a rectangular shape occasionally made square. The covers 2, 9 also overlap the left wall in length preventing moisture intrusion.

From time to time, a user may require access to the interior of the invention. FIG. 7 shows the invention with the front cover 2 and the rear cover 9 opening. The covers hingedly connect to a housing 19 at the top 14 of the housing. The housing has its bottom 16 opposite and beneath the top 14 and its ends a left end 18 shown and the opposite right end not shown in this figure. The bottom, top, left end, and right end cooperate to form a box like shape, generally rectangular. The front cover 2 opens outwardly and upwardly from the top on hinges 5 towards the hooks. As in FIG. 1, the front cover has various indicia 4 thereon. The indicia are preferably transparent with the remainder of the front cover as opaque. Each indicia has a retro reflective tape outline as previously described. The rear cover 9 also opens outwardly, that is away from the front cover upon its hinges 5. The top 14 of the housing provides the attachment points for the hooks 6. The hooks generally have a threaded connection to the top. The bights 13 of the hooks, outwardly from the top 14, extend towards the rear cover. Upon hanging the bights upon a window frame, door, door panel, or other line, the rear cover faces away from any person viewing the invention. And the bottom 16 allows the housing to receive two spikes 7, generally spaced apart that permit ground level installation of the invention. The spikes have tips 8 that ease embedment of the spikes into the ground.

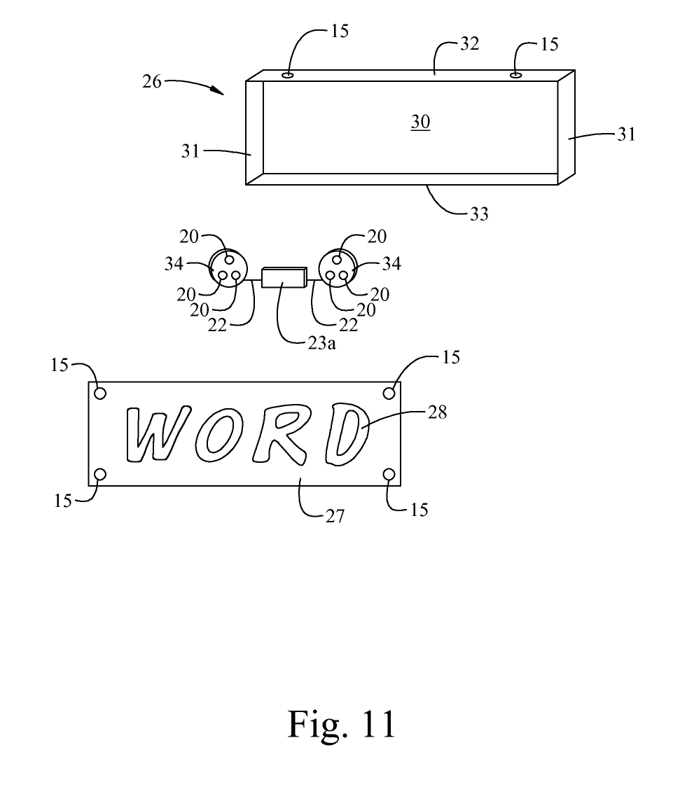

The previous figures have shown the invention as seen by a person viewing it in the closed position. From time to time, the invention can be opened as shown in FIG. 8. FIG. 8 shows a front view of the invention 1 with the front cover 2 lifted upon its hinges 5 upwardly towards the hooks 6. The front cover pivots upwardly to become generally coplanar with the top 14. The housing has its interior shown in this figure bounded by the right end 17, the bottom 16, the left end 18 and the rear cover 9 in the background. Within the interior of the invention, the invention provides for direct illumination of the indicia included upon the front cover 2. The illumination comes from at least one light emitting diode 20, or LED, here shown as two spaced apart pairs. The LEDs have positions behind the front cover, generally spaced inwardly from the ends for even illumination of the indicia. The LEDs are preferably yellow in color with the front cover being black. The yellow LEDs have a lesser cost than other colors of LED. An LED that appears white in color generally blends the light from other colors of LED, such as red, green, and blub where the usage of multiple colors increases the cost proportionally. Though this figure shows two pairs of LED, the Applicant foresees an alternate embodiment where the indicia take their form from strips of LED formed into the shapes of letters, numerals, and select designs. The LED generally rest upon stands 21 that spaced them upwardly from the bottom 16 for even illumination in the vertical direction. The LEDs receive direct current via wiring 22 in communication with a power source 23. The power source includes a battery 23a or a transformer 23b that steps down utility service supplied via a cord 24. As described in FIG. 3, the invention may include solar cells 15 upon the top. The solar cells provide direct current to the battery 23a through wiring 25 which allows for its recharge during daylight hours. As later described and shown in FIG. 11, additional components preserve battery life and regulate powered illumination of the invention during daylight in the preferred and alternate embodiments. These components also include a light sensor that detects the presence of sunlight and opens a switch preventing illumination of the lights, thus saving the battery. The light sensor also closes the switch during fog and inclement weather so that the alternate embodiment illuminates unlike during typical daylight hours. The components may also include a delayed off relay that extinguishes the light source gradually in the presence of sufficient sunlight as during daytime.

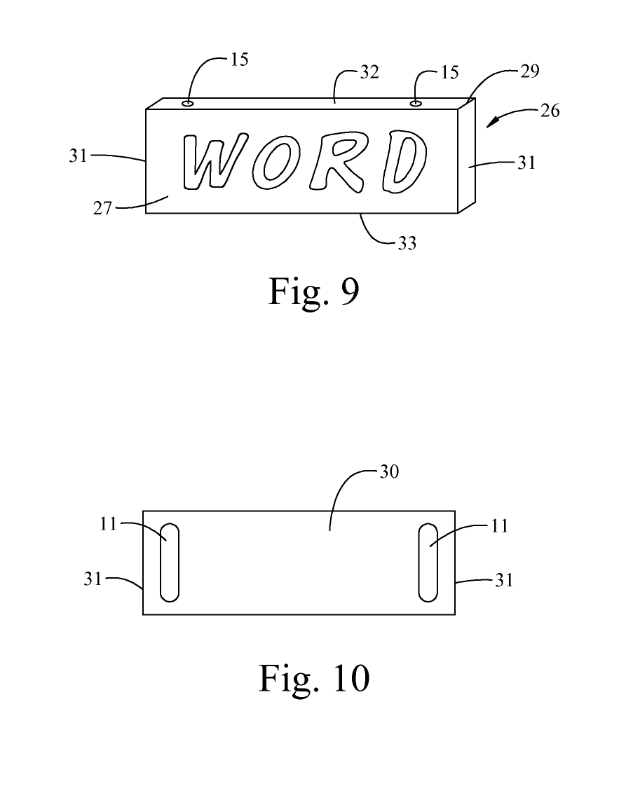

FIG. 9 shows an alternate embodiment of the invention for deployment upon a vehicle. This alternate embodiment has a case 26, generally rectangular in shape and thin in cross section, as at 29, suitable for application upon a vehicle. The case is thin enough to appeal to a driver's aesthetic sense and thick enough to contain the components of the invention as later shown. Being rectangular, the case has two lateral ends 31, a longitudinal top 32, and a longitudinal bottom 33 as shown. The top and bottom are mutually parallel and spaced apart, and perpendicular to the lateral ends. The lateral ends are generally lesser in length than the top and the bottom. The case has its front cover 27 having indicia 28 thereon being letters, numerals, or select designs. As above, the front cover 27 is generally opaque with preferably transparent indicia 28 therein and alternatively translucent indicia. The front cover generally does not overhang the remainder of the invention for less air resistance.

Opposite the front cover 27 of this alternate embodiment, FIG. 10 shows the rear cover 30 of the case. The rear cover is generally rectangular and opaque of generally similar dimensions as the front cover. The rear cover does not have any indicia thereon. The rear cover though has at least one vertical strip 11 that secures the rear cover to a vehicle surface. Preferably, the rear cover has two vertical strips, mutually parallel and spaced apart, proximate each end 31 as shown. In the preferred embodiment, the vertical strips include an adhesive with a release layer thereon. For installation, the user removes the release layer and places the adhesive upon the vehicle. This adhesive grasps metal and fiberglass and holds the invention in place upon a moving vehicle. Similar to bumper strips, the adhesive allows the user to remove the invention later from the vehicle without leaving reside behind. In an alternate embodiment, the vertical strips utilize strips of magnetic material affixed to the rear cover and with sufficient strength to support the weight of the invention from a ferrous metal surface, such as a vehicle body panel or bumper. The sizes of the vertical strips can be adjusted to provide a strong enough magnetic force to withstand the weight of the invention and wind forces encountered when a vehicle moves at highway speeds. In a further alternate embodiment, the rear cover has adhesive upon its entire surface covered in a release layer that the user removes for installation of the alternate embodiment upon a vehicle.

FIG. 11 shows an exploded view of the alternate embodiment. The case 26 is generally hollow defined by the rear cover 30, the top 32, the bottom 33, and the ends 31 similar to a thin box. The top includes at least one solar cell 15, here shown as two. The case has approximate dimensions of three inches by seven inches and a thickness of ⅜ inches or less. As shown in the figure, outwardly from the case, the invention includes at least one light 34, here shown as two for redundancy in the rugged vehicle environment. Each light has at least one LED 20 as previously described. Preferably, each light has three LED equally spaced. The lights receive direct current via wiring 22 from a battery 23a. The battery has a similar shape and construction as a battery for a cellular telephone. The battery can be recharged from exterior electrical supply of appropriate voltage, generally 12 volts, the vehicle's electrical system if desired by the driver, and by solar cells. Proximate the battery, this alternate embodiment includes additional components 34 that preserve battery life and heighten convenience for a driver. These components include an accelerometer 34a, or inertial switch, that detects when the vehicle has stopped and a relay 34b that turns the lights off after a predetermined time such as two minutes after the vehicle stops. These two components turn off the alternate embodiment, particularly its light, without attention of the driver. These components also include a light sensor 34c that detects the presence of sunlight and opens a switch preventing illumination of the lights, thus saving the battery. The light sensor also closes the switch during fog and inclement weather so that the alternate embodiment illuminates. And forward of the lights, battery, and components, this figure shows the front cover 27 with indicia 28 thereon. Alternatively, the front cover also includes a plurality of solar cells, 15, generally locating proximate the corners of the front cover outwardly from the indicia. The solar cells provide direct current via wiring to the battery as previously described.

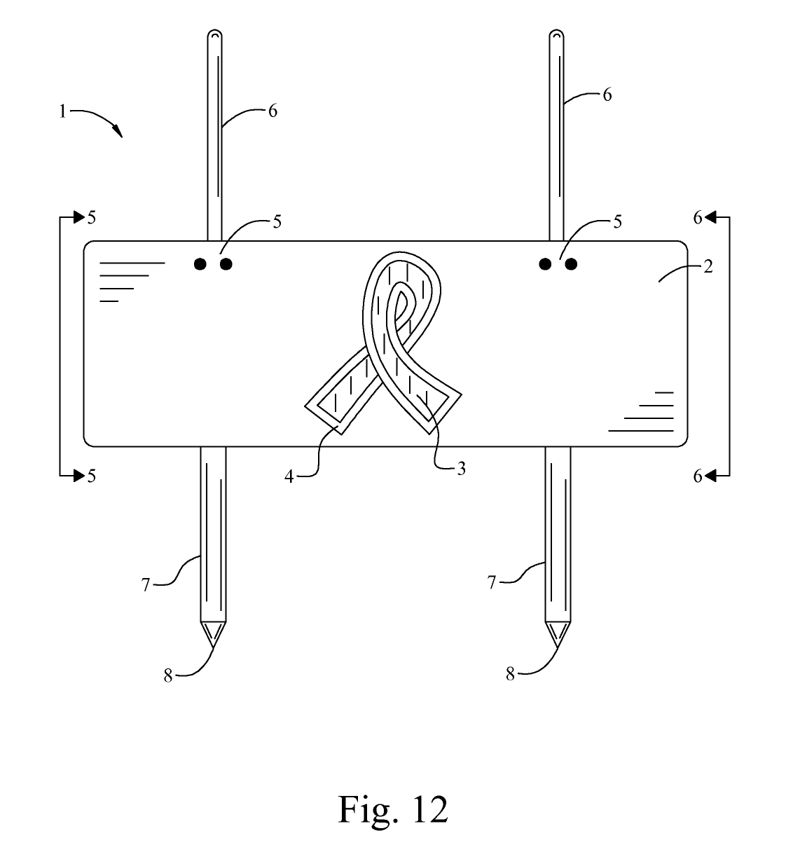

FIG. 12 describes a further alternate embodiment of the invention. This alternate embodiment has a similar housing, front cover, and rear cover and illumination means as described above and shown in FIG. 1. This alternate embodiment though has indicia 3 upon its front cover 2 having a ribbon like form in a figure eight shape with the lower portion of the shape truncation. Such ribbons have become popular in recent years for various worthy and charitable causes.

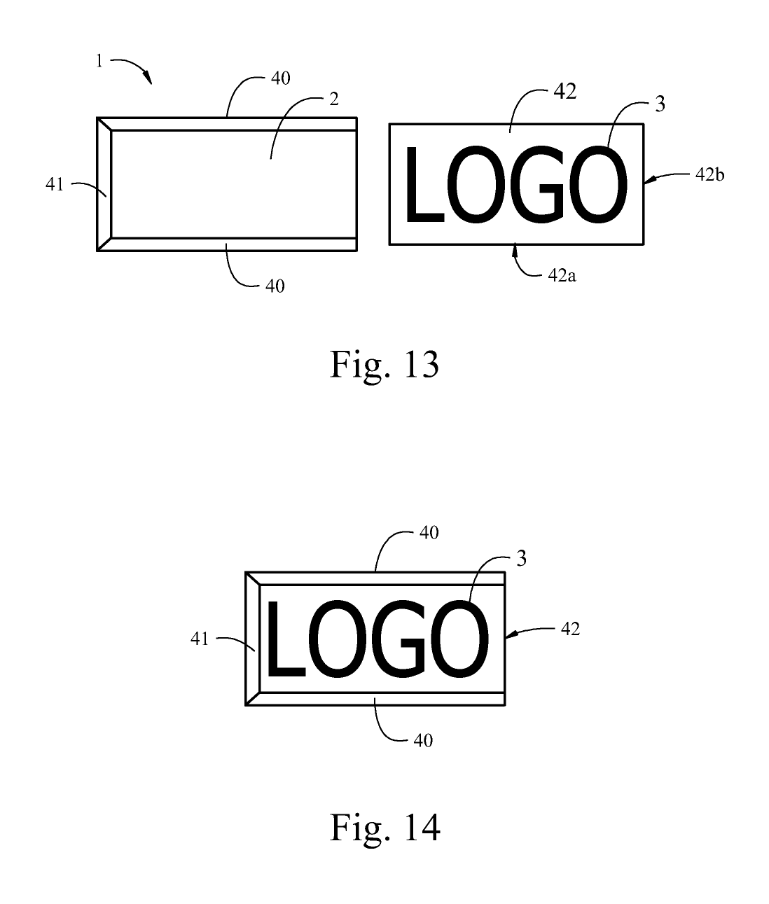

Augmenting the previous description, FIG. 13 shows a frame with a removable sign embodiment of the invention. In the left of the figure, a translucent cover 2 has a generally rectangular shape with two mutually parallel and spaced apart longitudinal edges and two mutually parallel and spaced apart lateral edges generally perpendicular to the longitudinal edges. The cover transmits sufficient lumens of light to illuminate an object placed upon the cover but insufficient light to form a discernable image when viewing the cover alone. The cover has two rails 40, each joining to a longitudinal edge, and spanning for the length of the longitudinal edges. The rails are horizontal, mutually parallel, and spaced apart. Upon one lateral edge, here shown as the left though the right is an alternate foreseen by the Applicant, the cover has a stile 41 joining to the lateral edge. In this figure, the stile joins to the rails using a mitered joint as shown though the Applicant also foresees a butt joint and the like. The rails and stile have a generally J shaped cross section as later shown. The rails and the stile have a slender, elongated shape for maximum transmission of light through the cover inwardly from the rails and stile.

The rails and stile receive a panel 42 inserted therein from the lateral edge opposite the stile. The panel also has a generally rectangular shape with two mutually parallel and spaced apart longitudinal edges 42a and two mutually parallel and spaced apart lateral edges 42b generally perpendicular to the longitudinal edges. The lateral edges of the panel are slightly less in length than the length of the stile 41. The panel has a transparent construction for transmitting the light from within the cover to the exterior of the invention for viewing. The panel illuminates any integral indicia or logo 3 as a discernable image. Preferably, the panel has indicia printed thereon in a contrasting color pattern such as yellow indicia upon a black background. The Applicant foresees other color combinations similar to those of highway sign color patterns approved by the American Association of State Highway and Transportation Officials. The indicia include letters, numbers, characters, punctuation marks, printed images and scenes, and other graphical elements.

FIG. 14 then shows the panel 42 inserted lateral edge first between the rails 40. The panel inserts for the length of the rails until one of its lateral edges, here the left, fits into the stile 41. The panel has the indicia or logo 3 outwardly. The panel has its right lateral edge generally flush with the cover's lateral edge. The light transmitting through the cover then illuminates the indicia or logo.

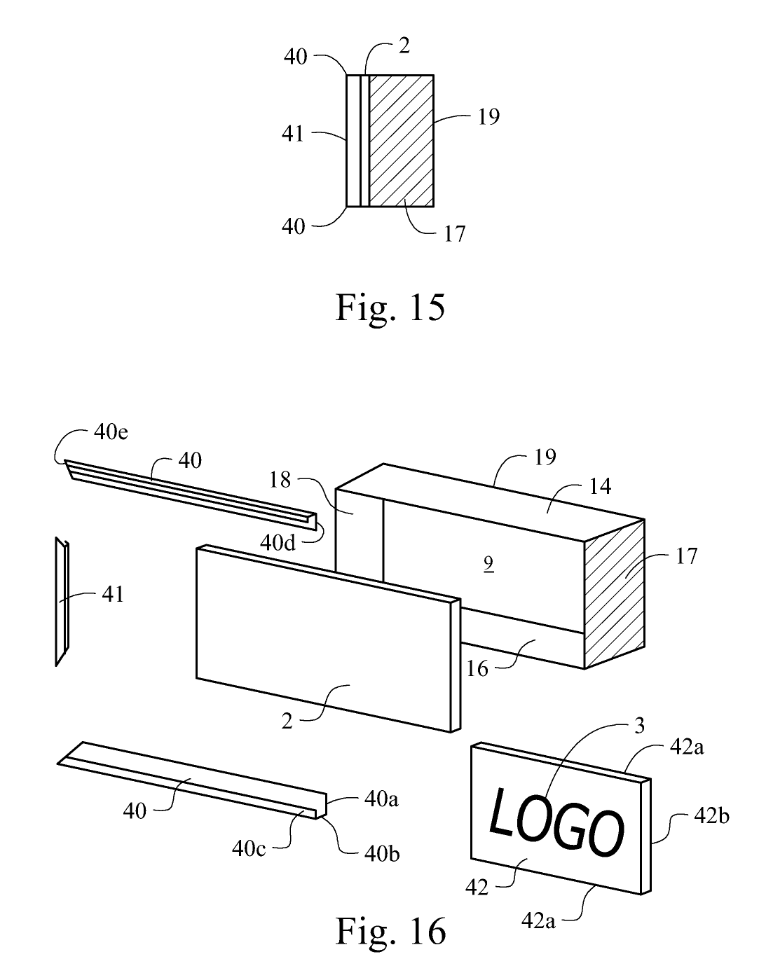

Turning this embodiment of the invention, FIG. 15 shows an end view with a housing 19 to the right. The housing has its end panel 17 shown in the foreground. Outwardly from the housing to the left of the figure, the embodiment has the cover 2 extending for the height of the housing, and by inference the length of the housing. Outwardly from the cover and opposite the housing, the two rails 40 have a mutually parallel and spaced apart position as shown. The rails utilize their J shaped cross section to form a channel that accepts the panel 3 as previously shown. In the background of the two rails, the stile 41 spans from rail to rail upon the opposite lateral edge of the cover from that edge in the foreground of the figure. The stile accepts one lateral edge 42b of the panel so that the edge fits within the cross section of the stile and the rails. The stile and rails cooperate to secure three edges of the panel upon the cover.

FIG. 16 then shows an exploded view of the components of this embodiment. The housing 19 has its rectangular shape as previously described. Here the housing has its top 14, right side 17, left side 18, bottom 16, and rear cover 9. Outwardly from the housing, the cover 2 has its generally rectangular form though translucent construction. Rightward in the figure, the panel 42 has its rectangular shape of slightly smaller dimensions than the cover and transparent construction. The panel includes its logo 3 which can be letters, numerals, designs, and the like. As previously described, the cover receives the panel in the channel formed between the rails and the stile. The rails 40 are generally mutually parallel and spaced apart and with the stile 41 located towards one end of both rails, here shown as the left. The left location of the stile allows for insertion of the panel from the right which comports with most users being right handed and more able to push the panel from the right inwardly. The rails and stile generally have a J shaped cross section with an upright spine 40a that adjoins the panel, a base 40b perpendicular to an end of the spine and generally extends perpendicular to the cover and outwardly from the cover, and a bight 40c perpendicular to the base but spaced away and generally parallel to the spine. The bight generally adjoins the panel 42 and prevents the panel from falling outwardly from the cover. The spine, base, and bight cooperate to for a generally J shape as shown.

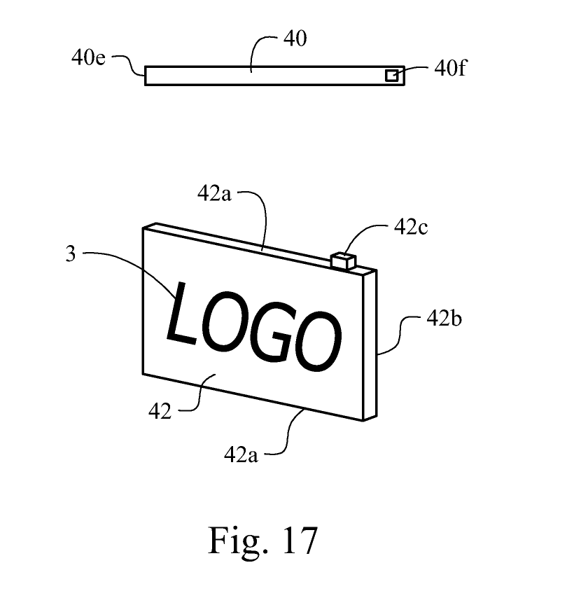

And, FIG. 17 illustrates a further alternate embodiment of the panel for securement to the rails. The panel 42 has its rectangular shape and construction with logo 3 as before. Proximate one lateral edge 42b, the panel though has at least on tab 42c extending outwardly from at least one longitudinal edge 42a. The tab has similar thickness as the panel but a short length, approximately 100 to 200% of the thickness. In cooperation with the panel, at least one rail has a slot 42d proximate one end, that is, opposite the stile. The slot has a shape that accepts the tab snugly. Preferably, the tab has a rectangular shape that fits into a rectangular shaped slot. A user inserts the panel 42 with one lateral edge between the rails and the tabs outwardly. The user then pushes the panel down the rails and across the cover. As the tabs approach the rails, the user deflects or bows, the panel slightly outwardly. In doing so, the tabs fit between the rails until the tabs engage the slots, allowing the panel to return to an unbowed position against the cover. The tabs and slots then prevent the panel falling out of the embodiment unless a user intervenes by bowing the panel again.

From the aforementioned description, a frame with a removable sign has been described. This frame and its sign are uniquely capable of inserting and removing a panel upon a translucent cover within rails and a cooperating stile. This frame and its sign allow for various transparent indicia placed upon or within a transparent panel including letters, numerals, graphics, and designs. The frame with removable sign and its various components may be manufactured from many materials, including but not limited to, brass, bronze, steel, aluminum, polymers, polyvinyl chloride, high density polyethylene, polypropylene, light emitting diodes, ferrous and non-ferrous metals, their alloys, and composites. Preferably the housing is 0.118 black acrylonitrile butadiene styrene—ABS—plastic, the cover is 0.125 translucent butyrate, and the panel is 0.040 polyethylene terephthalate—PETG with indicia printed or formed therein.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device presenting a message, said device attaching to a housing, said housing providing illumination of said device, said device comprising:
a translucent rectangular cover, said cover adapted to attach to said housing, said cover having a length;
two mutually parallel and spaced apart horizontal rails upon said cover and parallel to the length of said cover;
a stile perpendicular to said rails and spanning between said rails upon said cover, said stile having a length;
wherein said rails and said stile define a channel outwardly from said cover;
a transparent rectangular panel, said panel having integral indicia, said panel having a length and a width, the length of said panel being less than the length of said cover and the width of said panel being less than the length of said stile, wherein said panel is adapted to be illuminated from within said housing;
said panel inserting into said channel and overlaying said cover; and,
said rails and said stile holding said panel upon said cover.

2. The message device of claim 1 further comprising:
each of said rails and said stile having a J shaped cross section, said cross section including an elongated stem, a base extending outwardly from said stem, and a bight extending from said base spaced apart from said stem;
said bases of said rails and said stile adjoining said cover thus forming said channel; and,
wherein said panel fits within said bights of said rails and said stile when inserted into said channel.

3. The message device of claim 2 wherein said stile has two opposite ends and each of said rails has two opposite ends.

4. The message device of claim 3 wherein said stile joins to an end of each of said rails in one of a miter joint or a butt joint.

5. The message device of claim 1 wherein said cover is adapted to span across said housing wherein no light leaks outwardly between said cover and said housing.

6. The message device of claim 2 wherein said rails and said stile cooperate in fitting said panel tightly against said cover wherein no light leaks outwardly between said panel and said cover.

7. The message device of claim 1 wherein said panel inserts into said channel opposite said stile.

8. The message device of claim 3 further comprising:
is at least one of said rails having a slot in said base proximate one end opposite said stile; and,
at least one of said longitudinal edges of said panel having a tab extending outwardly from said at least one longitudinal edge and cooperatively engaging said slot therein securing said panel within said channel.

9. A device presenting a message, said device attaching to an housing, said housing providing illumination of said device, said device comprising:
a transparent rectangular panel, said panel having integral indicia, said panel having a length, a width, two mutually parallel and spaced apart longitudinal edges, wherein said panel is adapted to be illuminated from within said housing;
two mutually parallel and spaced apart horizontal rails parallel to the length of said panel, each of said rails having two opposite ends, a stile perpendicular to said rails and spanning between said rails, said stile having a length wherein said rails and said stile form a generally C shape;
a translucent rectangular cover, said cover adapted to attach to said housing, said cover having a length and two mutually parallel and spaced apart longitudinal edges, the length of said cover being more than the length of said panel and the width of said cover being similar to the length of said stile, wherein said rails join to said cover proximate the longitudinal edges and said stile joins to said cover perpendicular to said rails, and wherein said rails and stile define a channel receiving said panel inserted therein; and,
wherein said rails and said stile hold said panel tightly upon said cover and wherein no light leaks outwardly from said cover, wherein said cover is adapted to span across said housing and wherein no light leaks outwardly between said cover and said housing.

10. The message device of claim 9 further comprising:
each of said rails and said stile having a J shaped cross section, said J shaped cross section including an elongated stem, a base extending outwardly from said stem, and a bight extending from said base spaced apart from said stem;
said bases of said rails and said stile adjoining said cover and said bights of said rails and said stile mutually orienting to said cover thus forming said channel; and,
wherein said panel fits within said bights of said rails and said stile when inserted into said channel.

11. The message device of claim 10 further comprising:
one of said rails having a slot in said base proximate one end opposite said stile; and,
one of said longitudinal edges of said panel having a tab extending outwardly from said longitudinal edge and cooperatively engaging said slot therein securing said panel within said channel.
